(19) United States
(12) Patent Application Publication
(10) Pub. No.: US 2011/0315019 A1
(43) Pub. Date: Dec. 29, 2011

(54) HVAC RETURN AIR SYSTEM ACTUATOR DEVICE

(76) Inventors: Kent Lyon, Cypress, TX (US); Jym Daniel, Austin, TX (US)

(21) Appl. No.: 13/230,636

(22) Filed: Sep. 12, 2011

Related U.S. Application Data
(60) Provisional application No. 61/508,711, filed on Jul. 18, 2011.
(60) Provisional application No. 61/512,179, filed on Jul. 27, 2011.
(60) Provisional application No. 61/525,869, filed on Aug. 22, 2011.

(51) Int. Cl. B01D 46/42; B01D 46/00

(52) U.S. Cl. 96/418; 96/421; 96/222

(57) ABSTRACT

A heating, ventilating and air conditioning (HVAC) return air system actuator device which could, among other things, be employed to notify a user of a clogged air filter and/or disperse a fragrance into a forced air HVAC system is disclosed. In one embodiment the actuator device has a movable actuator mounted within a housing. The movable actuator moves in response to a user pre-set pressure differential. When the pre-set pressure differential is reached, the movable actuator impacts a lever which activates a switch. The switch could be connected to a host of items such as a light emitting device to notify the user to a clogged air filter condition and/or to activate a pump to release a fragrance into the HVAC system.

### CROSS-REFERENCE TO RELATED APPLICATIONS

This application claims the priority of U.S. Provisional No. 61/508,711 entitled “CLOGGED AIR FILTER INDICATOR DEVICE” and filed on Jul. 18, 2011. This application also claims the priority of U.S. Provisional No. 61/512,179 entitled “CLOGGED AIR FILTER INDICATOR DEVICE” and filed on Jul. 27, 2011. This application finally claims the priority of U.S. Provisional No. 61/525,869 entitled “HVAC RETURN AIR SYSTEM ACTUATOR DEVICE” and filed on Aug. 22, 2011.

### FIELD OF THE INVENTION

The invention relates generally to HVAC systems and more specifically to the detection and alert of a clogged filter in an HVAC system.

### BACKGROUND OF THE INVENTION

Per the U.S. Department of Energy's Energy Star website “A dirty filter will slow down air flow and make the system work harder to keep you warm or cool—wasting energy. A clean filter will also prevent dust and dirt from building up in the system—leading to expensive maintenance and/or early system failure” and yet studies have shown that 80% of all HVAC air filters are not changed at the appropriate time, thereby putting undue stress on the HVAC system and also the world's energy resources. Most people are aware of the above issues & additional significant costs but state that they just forget to change the air filter until they receive a large utility bill, only then they are committed to action.

Traditional mechanisms to detect and alert to a clogged air filter have enjoyed very limited success for a myriad of reasons, some of which are discussed below. For clarity, the return air portion of a typical HVAC system has a generally layout. The return air vent is positioned in a room. Air in that room is sucked through a grate, then a filter, then travels via ducting (or directly in some models) to the HVAC system itself. When used in this disclosure, the word “downstream” refers to any portion of the HVAC system after the air traverses through the filter (e.g. on the side of the filter facing the HVAC system or the side of the filter facing the ducting leading to the HVAC system). Whereas the “upstream” portion refers to any portion of the HVAC system before the air traverses through the filter (e.g. on the side of the filter facing the grate). Furthermore, throughout this disclosure the words “filter” and “air filter” are used interchangeably.

Devices for indicating when to change or clean an air filter are known in U.S. Pat. No. 7,713,339 (Johansson), for example, discloses a filter change indicator whose switch and notifying element is activated by the flex and bulge of the downstream side of the air filter medium itself. This has several disadvantages such as having to be installed on the downstream side of the air filter thereby increasing the difficulty of installation and monitoring of an alert situation (e.g. cannot be easily seen from the upstream side of the filter). Another disadvantage in this particular art is its relative inaccuracy because of its dependence on the flex and bulge of the air filter itself. Because air filters and their frames are made of different materials, different air filters have different rates of bulging and flexing. U.S. Pat. No. 3,928,006 (Martineau) & U.S. Pat. No. 6,734,801 (Scofield) also disclose devices which detect a predetermined extent of the downstream side of the filter medium bulge to actuate a filter change indicator. These exhibit similar deficiencies as discussed above.

U.S. Pat. No. 3,071,914 (Gesmar) discloses a filter condition indicator for a filter fan using a differential pressure gauge. The differential pressure gauge includes a hollow indicator tube and a float that moves in response to the pressure differential and is positioned downstream from the air filter. Besides being positioned on the downstream side of the filter, this has the additional problems of being so difficult to initially install that it usually requires the hiring of a trained HVAC technician. U.S. Pat. No. 6,190,442 (Redner) also discloses a differential pressure gauge by means of a vane and fluid which is positioned downstream from the air filter. This “solution” has the same problems as Gesmar.

U.S. Pat. No. 5,668,535 (Hendrix el al) discloses a filter condition sensor and indicator in which a heated thermistor is positioned in a by-pass air flow path. A by-pass air flow path is a cut in or through at least a portion of the air filter which increases the flow of air in the by-pass air flow path for cooling the heated thermistor. As the thermistor cools, the resistance in the circuit is lowered and an indicator is allowed to illuminate. This has the disadvantage of being relatively expensive, being difficult to install to the point of often requiring an HVAC technician, and having to cut a by-pass air flow path in each new filter.

Based on the foregoing, there is a need for an inexpensive device that reliably detects and alerts as to a clogged filter.

Additionally, it is often desired by a user to introduce a scent or fragrance into the HVAC system thereby allowing the HVAC system to disperse the scent or fragrance throughout the area/home. U.S. Pat. No. 6,177,218 (Snyder) discloses non-electrical devices which automatically freshen the air through a HVAC system by means of a gel deposited on a sheet in which the air flows past and scents the air are; however, such devices tend to deliver a strong scent when first installed and progressively weaken as time passes. U.S. Pat. No. 7,073,731 (Hess) discloses devices which dispense fragrance with an electronic device in a HVAC system as controlled by the discretion of the user; however, such devices tend to be rather expensive and rely on the user remembering to activate the device.

Based on the foregoing, there is a need for a simple, inexpensive and reliable device that can automatically disseminate a fragrance each time a HVAC system turns on, or during an HVAC cycle, thereby delivering a more constant and consistent level of fragrance in the air.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings and abstract as a whole.

One advantage of at least one embodiment of the disclosed subject matter is to provide a simple, inexpensive and reliable device that can accurately indicate to the user when to replace or clean an air filter in a HVAC system based on the degree the filter is clogged.

An additional advantage of at least one embodiment of the disclosed subject matter is to provide a device that is relatively insensitive to the multitude of various HVAC system designs including the various filter types.

Yet another advantage of at least one embodiment of the disclosed subject matter is to provide a device which has an alarm indicator that is triggered by a material within a housing of its' own which reacts and moves only when the filter becomes clogged to at least a predetermined level.

Another advantage of at least one embodiment of the disclosed subject matter is to provide a device that can be easily installed on the upstream side of an air filter.

Still another advantage of at least one embodiment of the disclosed subject matter is to provide a device that signals the user of a filters clogged condition by a relatively cheap and nonintrusive method such as a light.

An additional advantage of at least one embodiment of the disclosed subject matter is to provide an adjustment device which allows a user to fine tune when an alert condition occurs in part to accommodate different HVAC systems, filters, etc.

Yet another advantage of at least one embodiment of the disclosed subject matter is to provide an adjustment device which regulates the size of one or more vent holes which adjusts the force necessary to cause an alert.

Still another advantage of at least one embodiment of the disclosed subject matter is to provide a combination of (i) an attachment device which attaches the top of a housing to the return air system grate and (ii) a collapsible material attached to the bottom of the housing which by way of its' collapsibility automatically adjusts to contact the air filter medium/media.

An additional advantage of at least one embodiment of the disclosed subject matter is the ability to tie/adapt it for us as an electrical HVAC air freshening device which automatically disseminates a fragrance each time a HVAC system turns on.

Another advantage of at least one embodiment of the disclosed subject matter is to provide an actuation device capable of actuating various mechanisms within a residential style forced air heating, ventilating and air conditioning (HVAC) system the device comprising a housing, said housing comprising a distal end and a proximate end, said distal end having a housing distal end opening and said proximate end having a housing proximate end opening; a movable actuator, said movable actuator having a proximate side and a distal side and contained within said housing such that said distal side of said movable actuator substantially blocks air flow through said housing distal end opening when a pressure differential is below a predefined threshold, said pressure differential being the difference in pressure between an upstream side of an air filter and a downstream side of said air filter; wherein, when said pressure differential exceeds said predefined threshold, said movable actuator moves within said hosing and actuates a switch.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims. Additionally, any combination of one or more of the above advantageous may be combined to form one or more embodiments and nothing should be interpreted as requiring all of the above.

### BRIEF DESCRIPTION OF THE DRAWING

At least some of the novel features believed characteristic of the invention are set forth in the claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is an exploded view of a HVAC movable actuator device as attached to the inside of a forced air heating, ventilating or air conditioning return air grate and contacting the upstream side of a forced air heating, ventilating or air conditioning air filter;

FIG. 2 is a sectional view of the of the HVAC actuator device as attached to a fragmentary view of a forced air heating, ventilating or air conditioning grate and contacting the air filter;

FIG. 3 is a sectional view of an exemplary embodiment the HVAC actuator device which is a clogged filter indicator device and includes a light bulb as the electrical mechanism to be turned on as attached to a fragmentary view of a forced air heating, ventilating or air conditioning grate and contacting the air filter;

FIG. 4 is a sectional view of an exemplary embodiment the HVAC actuator device which is a HVAC air freshening device which includes a pump as the electrical mechanism and a fragrance canister as attached to a fragmentary view of a forced air heating, ventilating or air conditioning grate and contacting the air filter;

FIG. 5 is an exploded view of the air flow adjustment cap.

### DETAILED DESCRIPTION OF THE INVENTION

When a HVAC system is in operation with an air filter in place there is a pressure differential between the upstream side of the air filter and the downstream side of the air filter. The present device harnesses the power from this pressure differential to move the movable actuator within the housing which can be utilized to actuate various mechanisms at predetermined times.

One such exemplary embodiment is a mechanism which alerts of a clogged condition of the air filter. As the air filter collects dirt and dust, the air flow through the exposed air filter media is restricted causing a continued increase in the air pressure differential between the upstream side of the air filter and the downstream side of the air filter as the clogging worsens. The present device, as installed on the upstream side of the air filter, is designed to protect the area of the air filter medium beneath the installed device from collecting dirt and dust thereby allowing the free flow of air through the air filter medium in this protected area. When the air filter reaches a predetermined level of clogging, the pressure differential is strong enough within the environment created by the device to move a movable actuator, which triggers a switching mechanism connected to a light bulb, thereby illuminating the light bulb and notifying the user that the air filter is clogged and needs attention. To be more descriptive, generally, the junction between the movable actuator and the housing creates a seal that is substantially air tight when the pressure differential is below a certain threshold (e.g. the air filter is not clogged). In one embodiment, this seal is maintained by a lever maintaining pressure against one side of the movable actuator thereby creating pressure between the opposite side of the movable actuator and the housing. The seal is also maintained in some part by the forces of friction and gravity acting on the movable actuator. As the pressure differential builds enough to overcome the force of the lever and the inherent weight/friction of the movable actuator, air begins to flow around the movable actuator which creates a “lift” and provides additional force to overcome the lever and the weight/friction of the movable actuator. Once the combination of the air flow and the pressure differential exceeds a threshold, the lever actuates the switch thereby illuminating the light emitting device.

Another exemplary embodiment is a mechanism which automatically freshens the air through a HVAC system. Each time a HVAC unit is turned on, air is moved from the upstream side of an air filter through the HVAC return air system. The present device, as installed on the upstream side of the air filter, is designed to protect the area of the air filter medium beneath the installed device from collecting dirt and dust thereby allowing the free flow of air through the air filter medium in this protected area. Once configured, each time the HVAC system is turned on the pressure differential is strong enough within the environment created by the housing of the device to move the movable actuator, which triggers switching mechanism on a pump which sprays a fragrance on to the air filter medium or a fragrance pad. As the air flows through the air filter medium or fragrance pad the air is scented and disseminated throughout the areas serviced by the HVAC system air flow.

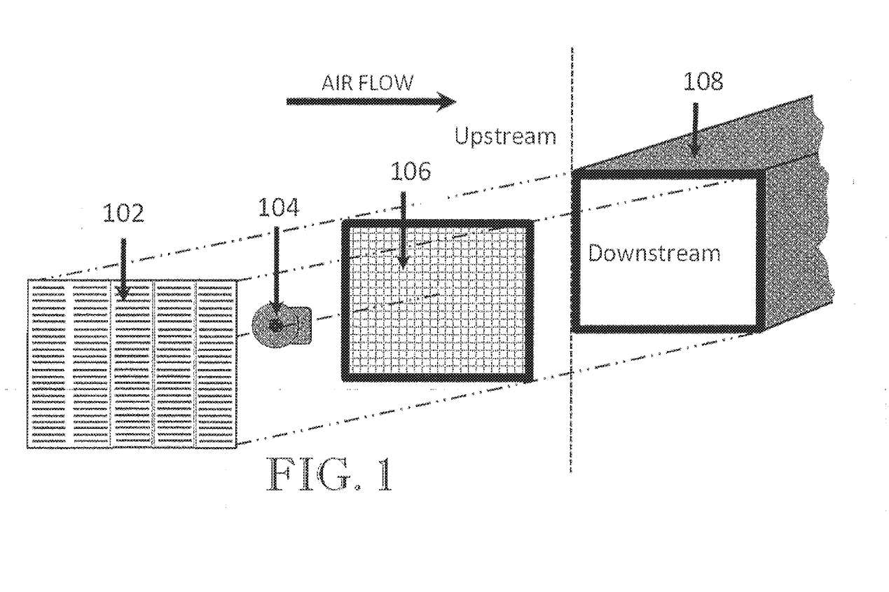

Referring now to the invention in more detail, FIG. 1 is an exploded view of the disclosed subject matter as it could be employed into an HVAC system. The HVAC actuator device 104 as attached between a forced air heating, ventilating or air conditioning return air grate 102 and a forced air heating, ventilating or air conditioning air filter 106 such that the HVAC actuator device 104 contacts the upstream side of the air filter 106 (e.g. the side of the air filter 106 facing the air grate 104). As is customary, the air filter 106 is fitted within or against an opening in the HVAC return air duct system 108 and the return air grate 102 is closed or fastened to the HVAC return air duct system 108. To provide additional clarity, the air flow flows through the return air grate 102 and some portion of the air flow impacts the HVAC actuator device 104 in addition to flowing through the air filter 106 and into the HVAC return air duct system 108.

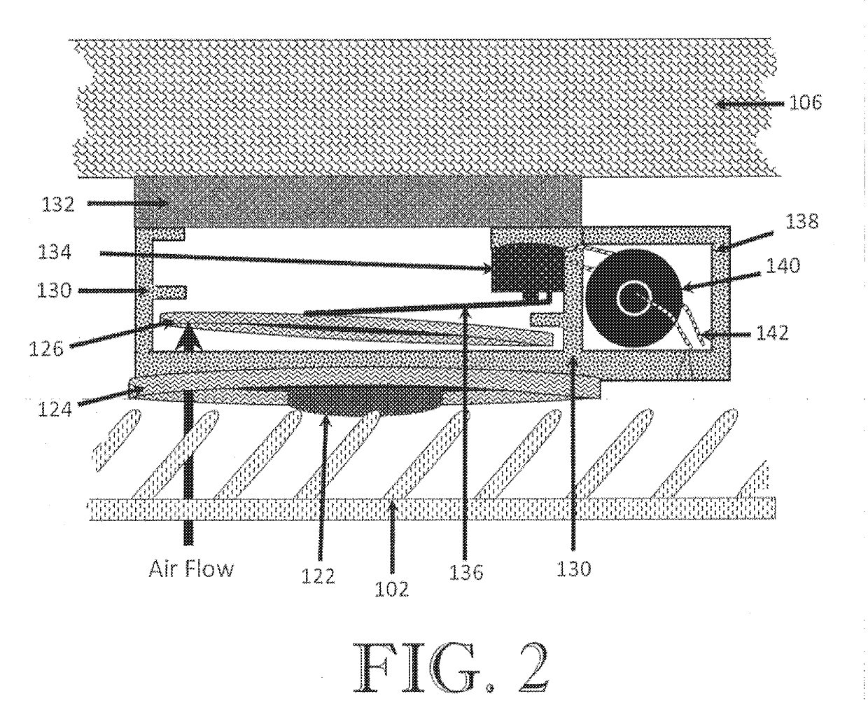

A sectional view in FIG. 2 of a HVAC actuator device 104 as it was employed above. In one embodiment, a magnet 122 contained within the air flow adjustment cap 124, attaches the HVAC actuator device 104 to the inside of return air grate 102 and an automatically adjusting compressible material 132 located on the opposite side from the magnet 122 (although described here as a magnet, nearly any other attachment device could also be employed to accomplish the same goal such as tape, clips, hangers, etc.). The compressible material 132 attaches to the housing 130 and collapses between the housing 130 and the air filter 106 such that the HVAC actuator device 104 contacts the surface of the air filter 106. As briefly discussed earlier, the compressible material 132 serves to protect an area of the air filter medium from particulate buildup. At a pre-determined level of pressure differential (between the upstream and downstream sides of the air filter 106) and as the air flows through the HVAC return air grates 102, the air flow adjustment cap 124 (see below for additional information regarding the purpose and operation of the air flow adjustment cap 124), and the housing 130, the movable actuator 126 is forced to move towards the air filter 106 and depress the lever 136 on the electrical switch 134. When the electrical switch 134 is depressed, it completes the electrical circuit through the electrical wires 142 that allows the batteries 140 to turn on an electrical mechanism. The batteries 140 and other various electronic mechanisms are held in section 138 of the housing. The movable actuator 126 could be a piece of plastic stiff enough to withstand flexion caused by the pressure differential but light enough to be moved by the pressure differential, a diaphragm device where the center deflects into the lever 136, or any other device, material, or item that moves enough to actuate the lever 136 in response to the pressure differential. To be more descriptive, generally, the junction between the movable actuator 126 and the housing 130 creates a seal that is substantially air tight when the pressure differential is below a certain threshold (e.g. the air filter 106 is not clogged). In one embodiment, this seal is maintained by a lever 136 maintaining pressure against one side of the movable actuator 126 thereby creating pressure between the opposite side of the movable actuator 126 and the housing 130. Additionally, the weight and frictional forces of the movable actuator 126 can also contribute to maintaining the seal. As the pressure differential builds enough to overcome the force of the lever 136 and the weight/frictional forces acting on the movable actuator 126, air begins to flow around the movable actuator 126 which provides additional force to overcome the lever and weight/frictional forces. Once the combination of the air flow and the pressure differential exceeds a threshold, the lever 136 actuates the switch thereby illuminating the light emitting device.

The aforementioned configuration of an electrical switch 134, electrical wires 142, and batteries 140 is but one embodiment which can utilize various components and configurations of an electrical system which when actuated will turn on an electrical mechanism and is shown here as merely one such example.

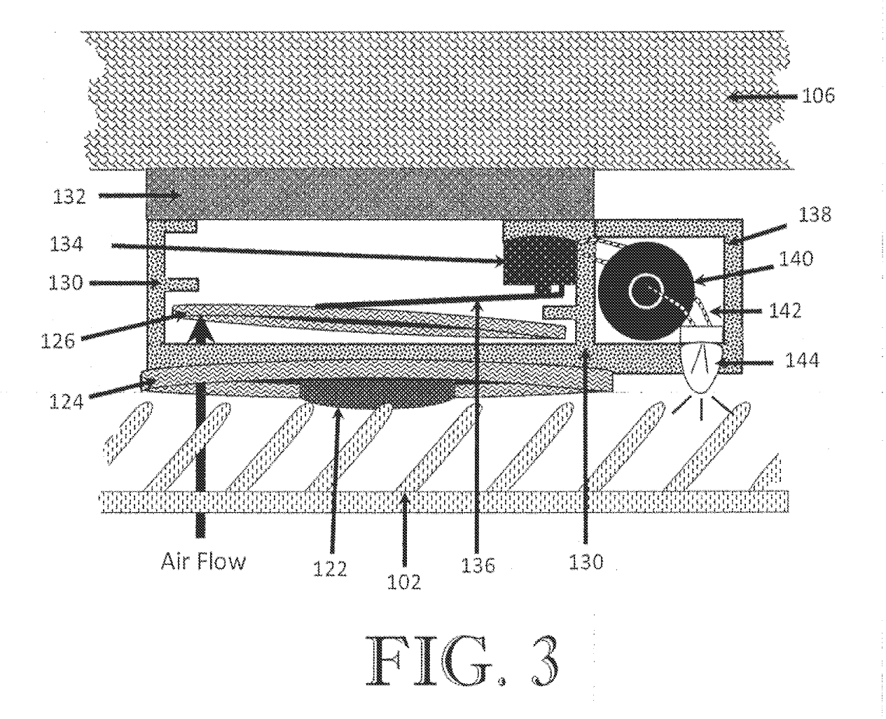

FIG. 3 is a sectional view of an exemplary embodiment of the HVAC actuator device 104 implemented as a clogged filter indicator including a light emitting device 144 as the alert device. The light emitting device could be a simple bulb, light emitting diode, or other such device. This embodiment general works as described above; however, when the movable actuator 126 depresses the lever 136 on the electrical switch 134, the electrical circuit between the batteries 140 and the light emitting device 144 completes and the light emitting device 144 is illuminated.

As the air filter collects dirt and dust, the air flow through the exposed air filter media (e.g. the portion not protected by the HVAC actuator device 104) is restricted causing a continued increase in the air pressure differential between the upstream side of the air filter and the downstream side of the air filter as the clogging worsens. As previously discussed, the HVAC actuator device 104, as installed on the upstream side of the air filter, is designed to protect an area of the air filter medium from collecting dirt and dust thereby allowing the free flow of air through the air filter medium in this protected area. When the air filter reaches a predetermined level of clogging, the pressure differential is strong enough within the environment created by the housing 130 of the device to move the movable actuator 126, which impacts a switch which provides electricity to light emitting device 144 and thereby notifies the user that a clogged air filter condition exists and it is time to change or clean the air filter.

The clogged air filter indication device and methods described herein can be utilized in a number of commercial applications. For example, the present invention can be incorporated into any system requiring the removal of debris from an air stream. The present invention can be extremely useful in HVAC systems and in any system requiring the use of air filters. The ability to change the air filter at proper times is crucial to the conservation of energy and the conservation of the world's resources.

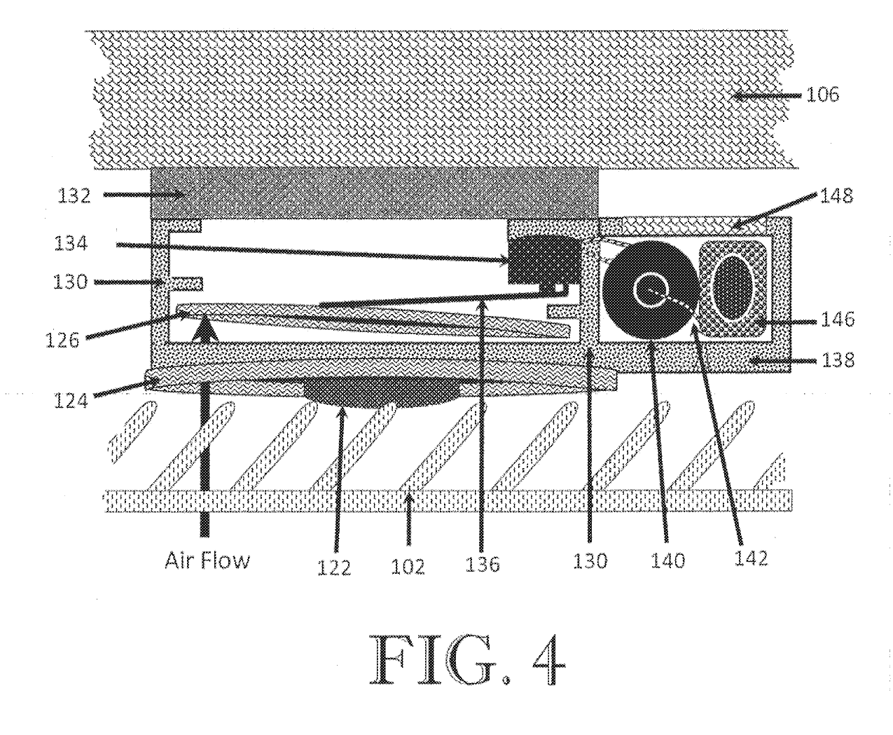

FIG. 4 sectional view of an exemplary embodiment the HVAC actuator device 104 which is a HVAC air freshening device. This embodiment acts similar to the previously described embodiments; however, a fragrance canister (or similar device holding a fragrance or scent) is attached to an electrically actuated pump 146. At a pre-determined level of pressure differential and as the air flows through the HVAC return air grates 102 and the air flow adjustment cap 124 and the housing 130, the movable actuator 126 is forced to move towards the air filter 106 and depress the lever 136 on the electrical switch 134. In this embodiment it may be advantageous to adjust the air flow adjustment cap 124 such that the pressure differential even with a clean and unclogged air filter 106 is sufficient to make the movable actuator 126 impact the lever 136 and therefore disperse some fragrance. This would allow the fragrance to be dispersed every time the HVAC system turned on. Additionally, in certain circumstances it may be advantageous to have the fragrance continue to disperse until the HVAC system turns off. In yet other circumstances it may be advantageous to have the fragrance continue to disperse until the lesser of the HVAC system turning off or a predetermined time/amount has elapsed/dispersed. This would help to protect against too much fragrance being dispersed throughout the HVAC system.

In yet another embodiment, instead of an electrically actuated pump 146, a heating element could be activated in response to the pressure differential and heat a reservoir of fragrance causing the fragrance to evaporate (or otherwise disperse) into the passing air.

Although shown as being an integral part of the HVAC actuator device 104, the light emitting device 104, the electrically actuated pump 146, and/or the heating element could be remote from the rest of the HVAC actuator device 104 and activated via a wired or wireless link.

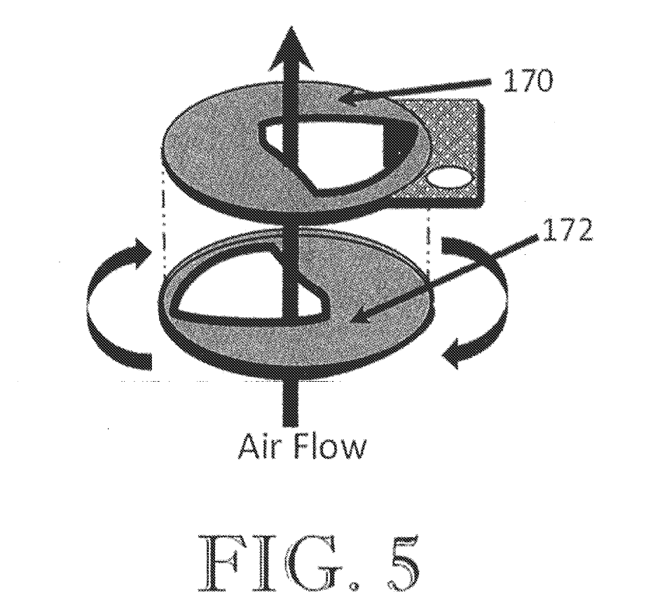

FIG. 5 is an exploded view of the air flow adjustment cap 124 where a top air flow adjustment cap 172 is nested onto a bottom air flow adjustment cap 170 which could be integrated directly into the housing 130 itself. As the top air flow adjustment cap 172 is rotated, the size of the vent hole regulates the air flow permitted through the housing 130. The larger the opening the less pressure differential is required for the movable actuator 126 to begin to move and impact the lever 136. Conversely, the smaller the opening the more pressure differential is required for the movable actuator 126 to begin to move and impact the lever 136. This is a simple yet elegant way to allow a user to adjust the HVAC actuator device 104 to their particular HVAC system and filter.

In an alternative embodiment, instead of or in addition to the air flow adjustment cap 124, different electrical switches 134 having different activation forces (e.g. 2 grams, 10 grams, etc.) and/or a different movable actuator 126 (e.g. different material stiffness, weight, etc.) could be employed to provide additional variation as to the pressure differential necessary to activate. Also, a longer, shorter, stiffer, or weaker lever 136 could be employed to accomplish the same goals.

In yet an additional alternative embodiment, a different attachment device other than a magnet can be employed and/or with or without an air flow adjustment device. Still further, the movable actuator could be attached to the housing with a hinge or other device as opposed to “freely floating” in the housing.

The embodiments and examples set forth herein are presented to best explain the present device and its practical application and to thereby enable those skilled in the art to make and utilize the device. Those skilled in the art, however, will recognize that the foregoing description and examples have been presented for the purpose of illustration and example only. Other variations and modifications of the present device will be apparent to those of skill in the art in conjunction with this disclosure, and it is the intent that such variations and modifications be within the scope of the appended claims.

The description as set forth is not intended to be exhaustive or to limit the scope of the present device. Many modifications and variations are possible in light of the above teaching without departing from the spirit and scope of the following claims. It is contemplated that the use of the present device can involve components having different characteristics. It is intended that the scope of the present device be defined by the claims appended hereto, giving full cognizance to equivalents in all respects.

What is claimed is:

1. A heating, ventilating and air conditioning (HVAC) return air system actuator device to alert to a possible clogged filter condition thereby allowing for efficient operation of the HVAC system and lowering energy consumption, the actuator device comprising:
a housing, said housing comprising a distal end and a proximate end, said distal end having a housing distal end opening and said proximate end having a housing proximate end opening;
a movable actuator, said movable actuator having a proximate side and a distal side and contained within said housing such that said distal side of said movable actuator substantially blocks air flow through said housing distal end opening when a pressure differential is below a predefined threshold, said pressure differential being the difference in pressure between an upstream side of an air filter and a downstream side of said air filter;
wherein, when said pressure differential exceeds said predefined threshold, said movable actuator moves within said housing and actuates a switch.

2. The device of claim 1, said housing being a frame of said air filter or embedded within said frame of said air filter.

3. The device of claim 1, wherein a seal is created between said proximate end of said housing and said upstream side of said air filter such that while said pressure differential is below said predefined threshold, the actuator device and said seal substantially prevents airborne particulate from accumulating on said air filter underneath the actuator device.

4. The device of claim 3, additionally comprising a compressible material between said distal end of said housing and said upstream side of said air filter to assist in preventing airborne particulate from accumulating on said air filter underneath the actuator device.

5. The device of claim 4, wherein the actuator device is attached to an air grate and said compressible material compresses to accommodate different distances between said air grate and said air filter to maintain contact between said compressible material and said air filter.

6. The device of claim 3, additionally comprising an adjustment device, said adjustment device adjusting the size of said housing distal end opening and/or said housing proximate end opening.

7. The device of claim 1, additionally comprising an adjustment device, said adjustment device adjusting the size of said housing distal end opening and/or said housing proximate end opening.

8. The device of claim 1, wherein said switch is an electrical switch which activates a light emitting device when actuated.

9. The device of claim 8, wherein said light emitting device is remote to the actuator device and activated via a wired or wireless connection.

10. The device of claim 8, wherein said light emitting device is mounted to said housing.

11. The device of claim 1, wherein said switch is an electrical switch which activates a fragrance emitting device.

12. The device of claim 11, wherein said fragrance emitting device includes a heating element.

13. The device of claim 11, wherein said fragrance emitting device includes an electrically actuated pump.

14. The device of claim 11, wherein said fragrance emitting device is remote to the actuator device and activated via a wired or wireless connection.

15. The device of claim 1, wherein said switch has an actuating force of between one gram and twenty grams.

16. The device of claim 1, additionally comprising a lever between said switch and said proximate side of said movable actuator.

17. The device of claim 1, wherein the actuator device requires no cutting of said air filter.

18. The device of claim 1, wherein the actuator device requires no access to the downstream side of said air filter.

19. The device of claim 1, wherein the actuator device is secured between an air grate and said upstream side of said air filter.

20. The device of claim 19, wherein the actuator device is secured to said air grate with a magnet.
